(19) United States
(12) Patent Application Publication
(10) Pub. No.: US 2026/0145859 A1
(43) Pub. Date: May 28, 2026

(54) VACUUM BARREL AND BARREL BODY THEREOF

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/368,189

(22) Filed: Oct. 24, 2025

(30) Foreign Application Priority Data
Nov. 25, 2024 (CN) 202422887758.3

(51) Int. Cl. B65D 81/20; A01K 5/00; B65D 1/26; B65D 43/16; B65D 53/02

(52) U.S. Cl. CPC B65D 81/2038; A01K 5/00; B65D 1/26; B65D 43/163; B65D 53/02; B65D 2543/00194; B65D 2543/00564; B65D 2543/00972

(57) ABSTRACT

A vacuum barrel and a barrel body thereof are provided. The present disclosure provides a barrel body of a vacuum barrel. The barrel includes a melamine barrel wall, a melamine shell flange, and a melamine bottom board. The melamine barrel wall is disposed in a closed ring shape. The melamine barrel wall defines a top opening and a bottom opening. The melamine shell flange is matched with the top opening. An edge of the melamine shell flange is sealed with the top opening. The melamine bottom board is disposed at the bottom opening. An edge of the melamine bottom board is sealed with the bottom opening. A food storage cavity is enclosed by the melamine shell flange, the melamine barrel wall, and the melamine bottom board. An opening is defined in the melamine shell flange to serve as an inlet of the food storage cavity.

### TECHNICAL FIELD

The present disclosure relates to a field of pet products, in particular to a vacuum barrel and a barrel body thereof.

### BACKGROUND

Vacuum barrels are a new product that has emerged in recent years. The vacuum barrels are configured to store pet food. By creating a vacuum, the vacuum barrels improve pet food storage efficiency and prevent spoilage and moisture. In the prior art, barrel bodies of the vacuum barrels are generally made of plastic. Plastic particles adhere to surfaces of the barrels bodies. When the pet food is stored in the barrel bodies, the plastic particles may easily adhere to the pet food, potentially harming the health of pets. Furthermore, barrel bodies made of plastic age over time, potentially causing the plastic to decompose and produce harmful substances, which is also detrimental to the health of the pets.

### SUMMARY

To solve defects in the prior art, the present disclosure provides a vacuum barrel and a barrel body thereof.

The present disclosure provides a barrel body of a vacuum barrel. The barrel comprises a melamine barrel wall, a melamine shell flange, and a melamine bottom board. The melamine barrel wall is disposed in a closed ring shape. The melamine barrel wall defines a top opening and a bottom opening. A shape of an outer contour of the melamine shell flange is matched with a shape of the top opening. The melamine shell flange is disposed at the top opening. An edge of the melamine shell flange is sealed with the top opening. The melamine shell flange is configured for sealing and mounting with a barrel cover. A shape of the outer contour of the melamine bottom board is matched with a shape of the bottom opening. The melamine bottom board is disposed at the bottom opening. An edge of the melamine bottom board is sealed with the bottom opening. A food storage cavity is enclosed by the melamine shell flange, the melamine barrel wall, and the melamine bottom board. An opening is defined in the melamine shell flange to serve as an inlet of the food storage cavity.

An inner wall of the top opening defines a mounting platform. A bottom portion of the edge of the melamine shell flange is bonded and sealed with the mounting platform.

A groove is defined in the bottom portion of the edge of the melamine shell flange. An adhesive is filled in the groove. The adhesive is configured to bond and seal the bottom portion of the edge of the melamine shell flange with the mounting platform.

The melamine shell flange comprises a guide board extending from a bottom portion of the melamine shell flange, and the guide board is inserted into the top opening.

The guide board is attached to an inner wall of the top opening.

The mounting platform is stepped, and the bottom portion of the edge of the melamine shell flange is bonded and sealed with a stepped surface of the mounting platform.

The melamine bottom board is integrally formed with an inner wall of the bottom opening.

Handle portions are disposed at a bottom portion of the melamine bottom board.

The present disclosure further provides the vacuum barrel. The vacuum barrel comprises the barrel body described above and the barrel cover. A sealing gasket is disposed at the bottom of the barrel cover. The barrel cover seals a top portion of the melamine shell flange through the sealing gasket. The barrel cover seals and covers the inlet of the food storage cavity. A vacuum pumping assembly is disposed on the barrel cover. The vacuum pumping assembly is configured to vacuum the food storage cavity.

The vacuum barrel further comprises a rotating connector. The rotating connector is disposed on the melamine shell flange. The barrel cover is hinged to the rotating connector.

By such configurations, the barrel body made of melamine is formed. When in use, pet food is allowed to be placed in and taken out through the inlet. The barrel body has a simple structure and is easy to use. Because the melamine is food-grade, the melamine is safe and reliable for storing the pet food, which is beneficial to health of pets. Furthermore, due to limited injection moldability of the melamine, the melamine is difficult to mold into complex shapes. Therefore, the barrel body of the present disclosure is relatively smooth as a whole, so that the barrel body is allowed to be made of melamine.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

The present disclosure is further described below with reference to the accompanying drawings and embodiments.

FIG. 1 is a top perspective schematic diagram of a barrel body according to one embodiment of the present disclosure.

FIG. 2 is a bottom perspective schematic diagram of the barrel body according to one embodiment of the present disclosure.

FIG. 3 is a cross-sectional schematic diagram of the barrel body according to one embodiment of the present disclosure.

FIG. 4 is an enlarged schematic diagram of portion A shown in FIG. 3.

FIG. 5 is a schematic diagram of a vacuum barrel according to one embodiment of the present disclosure, where a barrel cover is opened.

FIG. 6 is a schematic diagram of the vacuum barrel according to one embodiment of the present disclosure, where a barrel cover is closed.

FIG. 7 is an enlarged schematic diagram of portion B shown in FIG. 6.

### DETAILED DESCRIPTION

### Embodiment 1

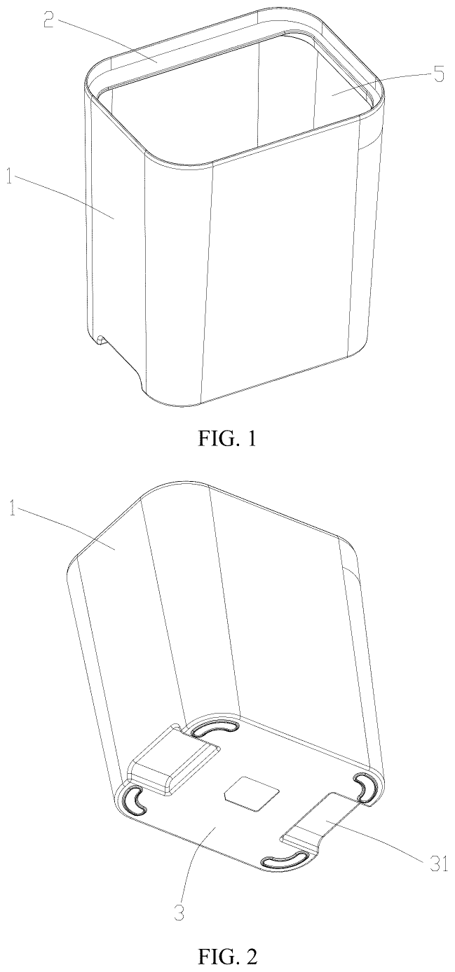

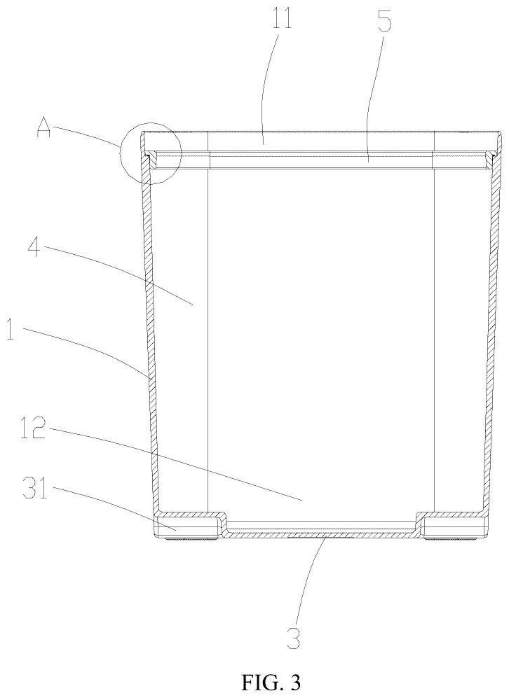

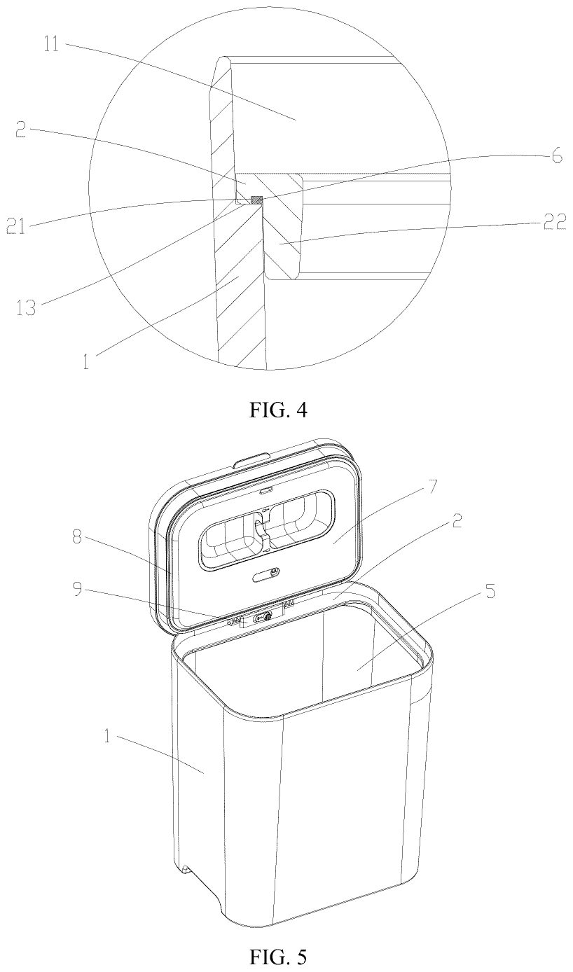

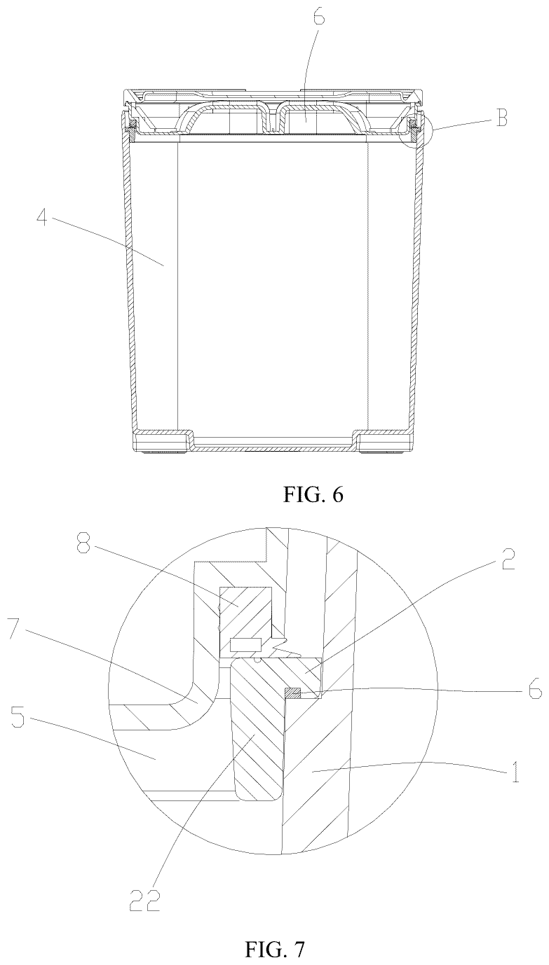

As shown in FIGS. 1-7, the present disclosure provides a barrel body of a vacuum barrel. The barrel comprises a melamine barrel wall 1, a melamine shell flange 2, and a melamine bottom board 3. The melamine barrel wall 1 is disposed in a closed ring shape. The melamine barrel wall 1 defines a top opening 11 and a bottom opening 12. A shape of an outer contour of the melamine shell flange 2 is matched with a shape of the top opening 11. The melamine shell flange 2 is disposed at the top opening 11. An edge of the melamine shell flange 2 is sealed with the top opening 11. The melamine shell flange 2 is configured for sealing and mounting with a barrel cover 7. A shape of the outer contour of the melamine bottom board 3 is matched with a shape of the bottom opening 12. The melamine bottom board 3 is disposed at the bottom opening 12. An edge of the melamine bottom board 3 is sealed with the bottom opening 12. A food storage cavity 4 is enclosed by the melamine shell flange 2, the melamine barrel wall 1, and the melamine bottom board 3. An opening 5 is defined in the melamine shell flange 2 to serve as an inlet of the food storage cavity 4. The closed ring shape may be a circular ring, a square ring, a hexagonal ring, etc.

By such configurations, the barrel body made of melamine is formed. When in use, pet food is allowed to be placed in and taken out through the inlet. The barrel body has a simple structure and is easy to use. Because the melamine is food-grade, the melamine is safe and reliable for storing the pet food, which is beneficial to the health of pets. Furthermore, due to limited injection moldability of the melamine, the melamine is difficult to mold into complex shapes. Therefore, the barrel body of the present disclosure is relatively smooth as a whole, so that the barrel body is allowed to be made of melamine.

In the embodiment, an inner wall of the top opening 11 defines a mounting platform 13. A bottom portion of the edge of the melamine shell flange 2 is bonded and sealed with the mounting platform 13. The barrel body has a simple structure and is easy to install. The mounting platform 13 is disposed along the inner wall of the top opening, that is, the mounting platform 13 is disposed in a closed ring shape.

Specifically, a groove 21 is defined in the bottom portion of the edge of the melamine shell flange 2. An adhesive 6 is filled in the groove 21. The adhesive 6 is configured to bond and seal the bottom portion of the edge of the melamine shell flange 2 with the mounting platform 13. The groove is disposed along the melamine shell flange, that is, the adhesive is also disposed along the melamine shell flange, and the groove and the adhesive are both adapted to the shape of the melamine shell flange. Specifically, the groove and the adhesive are both disposed in a closed ring shape.

Furthermore, the melamine shell flange 2 comprises a guide board 22 extending from a bottom portion of the melamine shell flange 2, and the guide board 22 is inserted into the top opening 11. The guide board 22 facilitates an installation of the melamine shell flange. In addition, the guide board 22 is attached to the inner wall of the top opening 11, making the barrel body more compact.

Furthermore, the mounting platform 13 is stepped, and the bottom portion of the edge of the melamine shell flange 2 is bonded and sealed with a stepped surface of the mounting platform 13, which facilitates an installation of the melamine shell flange 2.

In the embodiment, the melamine bottom board 3 is integrally formed with an inner wall of the bottom opening 12 to achieve sealing of the edge of the melamine bottom board 3 to the bottom opening 12, which has a simple structure and is easy to manufacture.

Handle portions 31 are disposed at a bottom portion of the melamine bottom board 3. The handle portions 31 are convenient for taking and placing the vacuum barrel. Specifically, the handle portions are disposed on two sides of the melamine bottom board, and the handle portions are recessed at the bottom portion of the melamine bottom board 3.

### Embodiment 2

As shown in FIGS. 1-7, the present disclosure further provides a vacuum barrel. The vacuum barrel comprises the barrel body described above and the barrel cover 7. A sealing gasket 8 is disposed at the bottom of the barrel cover 7. The barrel cover 7 seals a top portion of the melamine shell flange 2 through the sealing gasket 8. The barrel cover 7 seals and covers the inlet of the food storage cavity 4. A vacuum pumping assembly is disposed on the barrel cover 7. The vacuum pumping assembly is configured to vacuum the food storage cavity 4. The sealing gasket 8 is an annular sealing strip, and the barrel cover 7 defines an annular groove, and the sealing gasket 8 is embedded in the annular groove for fixing.

In the embodiment, the vacuum barrel further comprises a rotating connector 9. The rotating connector 9 is disposed on the melamine shell flange 2. The barrel cover 7 is hinged to the rotating connector 9 to achieve a rotatable connection between the barrel cover 7 and the barrel body, which has a simple structure and is easy to use. In addition, a first sensor is disposed in the rotating connector, and correspondingly, a second sensor is disposed in the barrel cover 7. When the barrel cover 7 is rotated to cover the inlet of the food storage cavity, the first sensor and the second sensor are inductively matched to determine whether the barrel cover is rotated in place.

The above descriptions provide one or more embodiments in conjunction with the specific content, and specific implementations of the present disclosure are not limited thereto. Any similarity or similarity with the methods, structures, etc. of the present disclosure, or any technical deduction or substitution based on the concept of the present disclosure, shall be deemed to be within the protection scope of the present disclosure.

What is claimed is:

1. A barrel body of a vacuum barrel, comprising:
a melamine barrel wall;
a melamine shell flange; and
a melamine bottom board;
wherein the melamine barrel wall is disposed in a closed ring shape, the melamine barrel wall defines a top opening and a bottom opening, and a shape of an outer contour of the melamine shell flange is matched with a shape of the top opening;
wherein the melamine shell flange is disposed at the top opening, and an edge of the melamine shell flange is sealed with the top opening, and the melamine shell flange is configured for sealing and mounting with a barrel cover;
wherein a shape of the outer contour of the melamine bottom board is matched with a shape of the bottom opening, the melamine bottom board is disposed at the bottom opening, and an edge of the melamine bottom board is sealed with the bottom opening;
wherein a food storage cavity is enclosed by the melamine shell flange, melamine barrel wall, and the melamine bottom board, and an opening is defined in the melamine shell flange to serve as an inlet of the food storage cavity.

2. The barrel body according to claim 1, wherein an inner wall of the top opening defines a mounting platform, and a bottom portion of the edge of the melamine shell flange is bonded and sealed with the mounting platform.

3. The barrel body according to claim 2, wherein a groove is defined in the bottom portion of the edge of the melamine shell flange, an adhesive is filled in the groove, and the adhesive is configured to bond and seal the bottom portion of the edge of the melamine shell flange with the mounting platform.

4. The barrel body according to claim 3, wherein the melamine shell flange comprises a guide board extending from a bottom portion of the melamine shell flange, and the guide board is inserted into the top opening.

5. The barrel body according to claim 4, wherein the guide board is attached to an inner wall of the top opening.

6. The barrel body according to claim 2, wherein the mounting platform is stepped, and the bottom portion of the edge of the melamine shell flange is bonded and sealed with a stepped surface of the mounting platform.

7. The barrel body according to claim 1, wherein the melamine bottom board is integrally formed with an inner wall of the bottom opening.

8. The barrel body according to claim 7, wherein handle portions are disposed at a bottom portion of the melamine bottom board.

9. A vacuum barrel, comprising:
the barrel body according to claim 1; and
the barrel cover;
wherein a sealing gasket is disposed at the bottom of the barrel cover, the barrel cover seals a top portion of the melamine shell flange through the sealing gasket, the barrel cover seals and covers the inlet of the food storage cavity, a vacuum pumping assembly is disposed on the barrel cover, and the vacuum pumping assembly is configured to vacuum the food storage cavity.

10. The vacuum barrel according to claim 9, wherein the vacuum barrel further comprises a rotating connector, the rotating connector is disposed on the melamine shell flange, and the barrel cover is hinged to the rotating connector.
